(19) United States
(12) Patent Application Publication
(10) Pub. No.: US 2025/0324387 A1
(43) Pub. Date: Oct. 16, 2025

(54) ADAPTIVE POSITIONING MEASUREMENT

(71) Applicant: Nokia Technologies Oy, Espoo (FI)

(72) Inventors: Tao TAO, Shanghai (CN); Dong LI, Shanghai (CN); Ryan KEATING, Naperville, IL (US); Oana-Elena BARBU, Aalborg (DK); Benny VEJLGAARD, Aalborg (DK); Johannes HARREBEK, Aalborg (DK); Jan Torst HVIID, Aalborg (DK)

(21) Appl. No.: 18/870,207

(22) PCT Filed: Jun. 2, 2022
(86) PCT No.: PCT/CN2022/097006

§ 371 Date: Nov. 27, 2024

(51) Int. Cl. H04W 64/00; H04B 17/318; H04L 5/00; H04W 24/10

(52) U.S. Cl. CPC H04W 64/00; H04B 17/328; H04L 5/0051; H04W 24/10

(57) ABSTRACT

A first device (110) receives a signal from a second device (120) on a first resource and PRS from at least one third device (131-1,131-2) on a second resource. The first resource overlaps the second resource in time domain and partially overlaps the second resource in frequency domain. Further, the first device (110) determines at least one of the following: quality of the received signal, quality of the received PRS, or configuration information about positioning measurement for the first device. The first device (110) also selects, based on the determination, one of positioning measurement operations for the first device (110). In turn, the first device (110) performs the selected positioning measurement operation.

### FIELD

Embodiments of the present disclosure generally relate to the field of telecommunication and in particular, to a method, device, apparatus and computer readable storage medium for adaptive positioning measurement.

### BACKGROUND

A New radio (NR) system provides positioning support. A terminal device may perform a positioning measurement operation based on positioning reference signals (PRSs) received from at least one non-serving network device. However, at the same time, the terminal device may receive a signal from a serving network device. Thus, the PRSs may collide with the signal from the serving network device. Such a collision cannot be fully avoided in current NR positioning. The main drawback from positioning point of view is positioning accuracy degradation due to the collision.

### SUMMARY

In general, example embodiments of the present disclosure provide a solution for adaptive positioning measurement.

In a first aspect, there is provided a first device. The first device comprises at least one processor and at least one memory storing instructions. When the instructions are executed by the at least one processor, the instructions cause the first device at least to: receive a signal from a second device on a first resource and PRS from at least one third device on a second resource, the first resource overlapping the second resource in time domain and partially overlapping the second resource in frequency domain; determine at least one of the following: quality of the received signal, quality of the received PRS, or configuration information about positioning measurement for the first device; and select, based on the determination, one of positioning measurement operations for the first device; and perform the selected positioning measurement operation.

In a second aspect, there is provided a method implemented at a first device. The method comprises: receiving, at the first device from a second device, a signal on a first resource and PRS from at least one third device on a second resource, the first resource overlapping the second resource in time domain and partially overlapping the second resource in frequency domain; determining at least one of the following: quality of the received signal, quality of the received PRS, or configuration information about positioning measurement for the first device; and selecting, based on the determination, one of positioning measurement operations for the first device; and performing the selected positioning measurement operation.

In a third aspect, there is provided an apparatus. The apparatus comprises: means for receiving, at a first device from a second device, a signal on a first resource and PRS from at least one third device on a second resource, the first resource overlapping the second resource in time domain and partially overlapping the second resource in frequency domain; means for determining at least one of the following: quality of the received signal, quality of the received PRS, or configuration information about positioning measurement for the first device; and means for selecting, based on the determination, one of positioning measurement operations for the first device; and means for performing the selected positioning measurement operation.

In a fourth aspect, there is provided a non-transitory computer readable medium comprising a computer program for causing an apparatus to perform at least the method according to the above third or fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication network in which embodiments of the present disclosure may be implemented;

FIG. 2 illustrates an example of PRS and SSB collision according to some example embodiments of the present disclosure;

FIG. 3 illustrates a relationship between positioning accuracy and SIR according to some example embodiments of the present disclosure;

FIG. 4 illustrates a flowchart of a method implemented at a first device according to some example embodiments of the present disclosure;

FIG. 5 illustrates a flowchart of a method implemented at a first device according to other example embodiments of the present disclosure;

FIG. 6 illustrates a simulation result of a method according to other example embodiments of the present disclosure;

FIG. 7 illustrates a simplified block diagram of an apparatus that is suitable for implementing embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), a relay, a low power node such as a femto, a pico, and so forth, depending on the applied terminology and technology. An RAN split architecture comprises a gNB-CU (Centralized unit, hosting RRC, SDAP and PDCP) controlling a plurality of gNB-DUs (Distributed unit, hosting RLC, MAC and PHY).

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

Although functionalities described herein can be performed, in various example embodiments, in a fixed and/or a wireless network node may, in other example embodiments, functionalities may be implemented in a user equipment apparatus (such as a cell phone or tablet computer or laptop computer or desktop computer or mobile IOT device or fixed IOT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

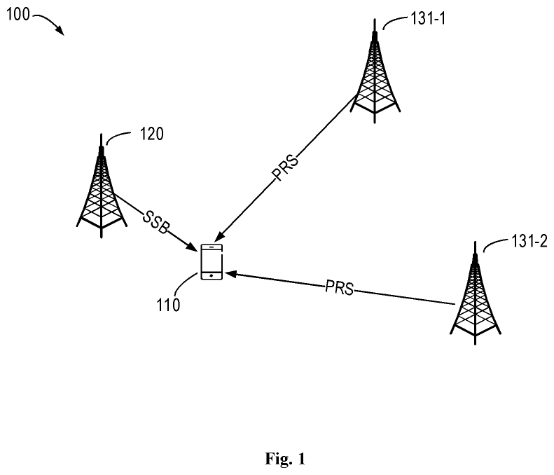

FIG. 1 shows an example communication network 100 in which embodiments of the present disclosure can be implemented. The network 100 includes a first device 110, a second device 120, and third devices 130-1 and 130-2 that can communicate with each other.

In some embodiments, some of the first device 110, the second device 120 and the third devices 130-1 and 130-2 may be implemented as terminal devices, and others may be implemented as network devices. In such embodiments, for example, the first device 110 may be implemented as a terminal device, and each of the second device 120 and the third devices 130-1 and 130-2 may be implemented as a network device. In such embodiments, the second device 120 may be serving the first device 110, and each of the third devices 130-1 and 130-2 are not serving the first device 110. In addition, in such embodiments, each of the second device 120 and the third devices 130-1 and 130-2 may be implemented as a transmission reception point (TRP).

In other embodiments, each of the first device 110, the second device 120 and the third devices 130-1 and 130-2 may be implemented as a terminal device. In such embodiments, the first device 110, the second device 120 and the third devices 130-1 and 130-2 may communicate with each other via a sidelink therebetween.

It is to be understood that the number of network devices and terminal devices is only for the purpose of illustration without suggesting any limitations. The network 100 may include any suitable number of network devices and terminal devices adapted for implementing embodiments of the present disclosure. Although not shown, it would be appreciated that one or more terminal devices may be served by the second device 120.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

The first device 110 receives a signal from the second device 120 on a first resource. In addition, the first device 110 receives PRS from at least one of the third devices 130-1 and 130-2 on a second resource. The first device 110 performs a positioning measurement operation based on the received PRS.

The first resource overlaps the second resource in time domain. For example, if the first resource and the second resource comprise the same symbol, the first resource overlaps the second resource in time domain. In addition, the first resource partially overlaps the second resource in frequency domain. For example, if subcarriers comprised in the second resource partially overlap subcarriers comprised in the first resource, the first resource partially overlaps the second resource in frequency domain. In other words, a collision between the signal from the second device 120 and the PRS occurs. In this case, from positioning point of view, the signal from the second device 120 may be considered as additional interference. Positioning accuracy may degrade due to the additional interference.

In some embodiments, the signal from the second device 120 may comprise at least one of the following: a reference signal, data or control information.

In some embodiments, the reference signal or control information from the second device 120 may include but is not limited to a Synchronization Signal and Physical Broadcast Channel (PBCH) block (SSB).

In some embodiments, the data from the second device 120 may include but is not limited to data associated with Ultra-reliable and Low Latency Communications (URLLC) traffic transmission.

Hereinafter, some embodiments of the present disclosure will be described by taking the SSB as an example of the reference signal. In this case, the collision between the signal from the second device 120 and the PRS may be referred to as a collision between the SSB and the PRS.

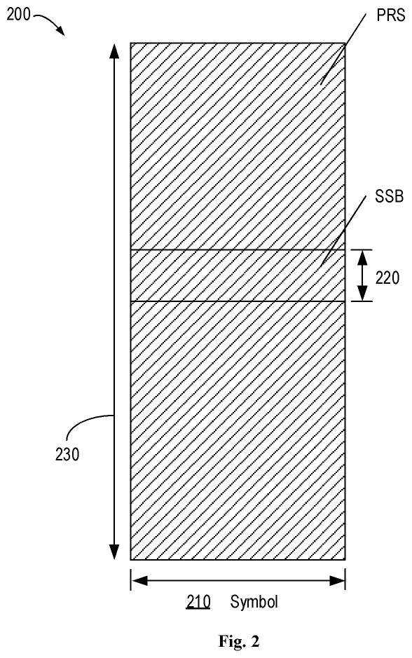

FIG. 2 illustrates an example 200 of a collision between the SSB and the PRS according to some example embodiments of the present disclosure. In the example 200, in order to maintain synchronization with the second device 120, the first device 110 receives SSB from the second device 120 on a symbol 210 and a first set of resource elements (REs) 220. In addition, in order to perform a positioning measurement operation, the first device 110 receives PRS from at least one of the third devices 130-1 and 130-2 on the symbol 210 and a second set of REs 230. The second set of REs 230 partially overlaps the first set of REs 220. In other words, a collision between the SSB and the PRS occurs.

The main reason of the collision may be that at least one PRS configuration from at least one of the third devices 130-1 and 130-2 is determined by the at least one of the third devices 130-1 and 130-2 itself. The third devices 130-1 and 130-2 may not know an SSB configuration from the second device 120. Thus, it is not possible to avoid such a collision due to configuration agnostic.

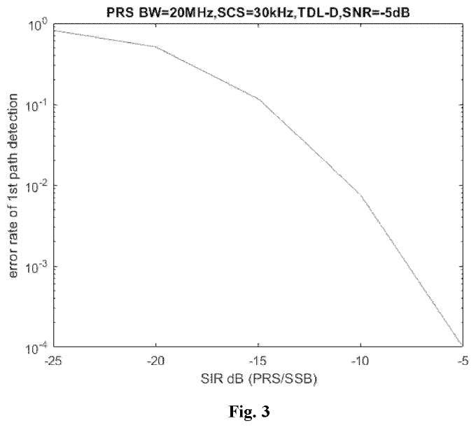

When the collision happens, the SSB with a high received power will greatly interfere PRS with a lower received power. FIG. 3 illustrates a relationship between positioning accuracy and SIR according to some example embodiments of the present disclosure. As shown in FIG. 3, Time of Arrival (ToA) estimation error will be very large in low Signal and Interference Ratio (SIR) case even in Line of Sight (LOS) scenario. The SIR is equal to a ratio of a received power of the PRS to a received power of the SSB. It is worth to mentioning that the SIR could be much lower than −25 dB if the first device 110 expects to receive the PRS from a very far away third device 130-1 or 130-2.

In view of the above, how to increase positioning accuracy is discussed.

According to some example embodiments, there is provided a solution for adaptive positioning measurement. According to the solution, when a collision between signal from a second device and PRS from at least one third device occurs, a first device determines at least one of the following: quality of the received signal, quality of the received PRS, or configuration information about positioning measurement for the first device. Then, the first device selects, based on the determination, one of positioning measurement operations for the first device and performs the selected positioning measurement operation. In this way, positioning measurement accuracy may be improved when the collision occurs.

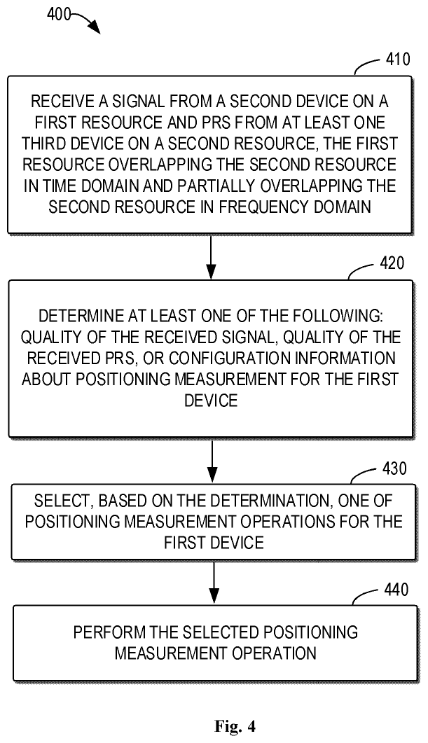

Reference is now made to FIG. 4, which shows a flowchart of an example method 400 implemented at a first device in accordance with some example embodiments of the present disclosure. For the purpose of discussion, the method 400 will be described from the perspective of the first device 110 with reference to FIG. 1. However, the method 400 may be likewise applied to other communication scenarios.

At block 410, the first device 110 receives signal from the second device 120 on a first resource and PRS from at least one of the third devices 130-1 and 130-2 on a second resource. The first resource overlaps the second resource in time domain and partially overlaps the second resource in frequency domain.

At block 420, the first device 110 determines at least one of the following:
quality of the received signal,
quality of the received PRS, or
configuration information about positioning measurement for the first device 110.

At block 430, the first device 110 selects, based on the determination, one of positioning measurement operations for the first device 110. In other words, the first device 110 may select one of the positioning measurement operations to measure the PRS.

At block 440, the first device 110 performs the selected positioning measurement operation.

With the method 400, positioning measurement accuracy may be improved when PRS collides with SSB or potential other signals.

In some embodiments, the positioning measurement operations may comprise acquisition of time and/or angle measurements characterizing one or more third devices required as input to a location estimation method for the first device 110.

In some embodiments, the location estimation method may comprise one of the following:
Downlink Time Difference of Arrival (DL-TDOA),
Uplink Time Difference of Arrival (UL-TDOA),
Downlink Angle of Departure (DL-AoD),
Uplink Angle of Arrival (UL-AoA), or
Multi-cell Round Trip Time (Multi-RTT).

In some embodiments, the positioning measurement operations comprise a first positioning measurement operation over whole resource elements of the second resource. In such embodiments, the first device 110 may perform the first positioning measurement operation over the whole resource elements. In some embodiments, the first positioning measurement operation may comprise a first correlation operation.

Alternatively or additionally, the positioning measurement operations comprise a second positioning measurement operation over partial resource elements of the second resource. The partial resource elements do not overlap the first resource. In such embodiments, the first device 110 may perform the second positioning measurement operation over the partial resource elements. In some embodiments, the second positioning measurement operation may comprise a second correlation operation.

Consider the example as shown in FIG. 2. In this example, the first device 110 may perform the first positioning measurement operation over the whole second set of REs 230. Alternatively or additionally, the first device 110 may perform the second positioning measurement operation over part of the second set of REs 230 which does not overlap the first set of REs 220.

In this example, to realize the second positioning measurement operation, a filter may be applied to filter out the signal on the first set of REs 220 before the second positioning measurement operation is performed on the second set of REs 230.

Alternatively, in order to further improve positioning measurement accuracy, some adjacent REs around the first set of REs 220 may also be ruled out.

In some embodiments, the first positioning measurement operation may comprise a successive interference cancellation (SIC) operation. In such embodiments, the first device 110 may firstly decode the SSB from the first set of REs 220. Then, the first device 110 may cancel the SSB from a received signal comprising the SSB and the PRS. In turn, the first device 110 may perform the first positioning measurement operation on the received signal without the SSB.

In some embodiments, the first device 110 may determine the quality of the received PRS by determining a first ratio of a received power of the PRS to noise power.

Alternatively or additionally, in some embodiments, the first device 110 may determine the quality of the received PRS and the quality of the received signal by determining a second ratio of a received power of the PRS to a received power of the signal from the second device 120.

In some embodiments, the first device 110 may determine the second ratio based on a third ratio of a received power of a first reference signal previously measured from the second device 120 and a received power of a second reference signal previously measured from the third device 130-1 or 130-2.

In such embodiments, each of the first reference signal and the second reference signal comprises one of the following: an SSB, or a channel state information reference signal (CSI-RS).

Alternatively, in embodiments where the quality of the received PRS comprises the second ratio of the received power of the PRS to the received power of the signal, the first device 110 may determine the second ratio based on a distance between the second device 120 and the third device 130-1 or 130-2.

In such embodiments, the first device 110 may obtain the distance from a location management function (LMF). Alternatively, the first device 110 may have already known the distance in UE-based positioning mode because the first device 110 knows allocation of the second device 120, the third devices 130-1 and 130-2.

Alternatively, in embodiments where the quality of the received PRS comprises the second ratio of the received power of the PRS to the received power of the signal, the first device 110 may determine the second ratio based on an angle between the second device 120 and the third device 130-1 or 130-2.

In such embodiments, the first device 110 may obtain the angle from the LMF. Alternatively, the first device 110 may have already known the angle from previous receptions of PRS and SSB.

In some embodiments, the configuration information about the positioning measurement for the first device 110 may comprise at least one of the following:
a first bandwidth of the PRS,
a ratio of the first bandwidth to a second bandwidth of the signal,
capability of the first device 110,
an operation mode of the first device 110, or
positioning Quality of Service (QOS) requirements.

In some embodiments, the operation mode of the first device 110 may comprise one of the following: a radio resource control (RRC)-connected mode, an RRC-inactive mode, an RRC-idle mode or a power saving mode.

In some embodiments, the positioning QOS requirements may comprise positioning accuracy or positioning latency.

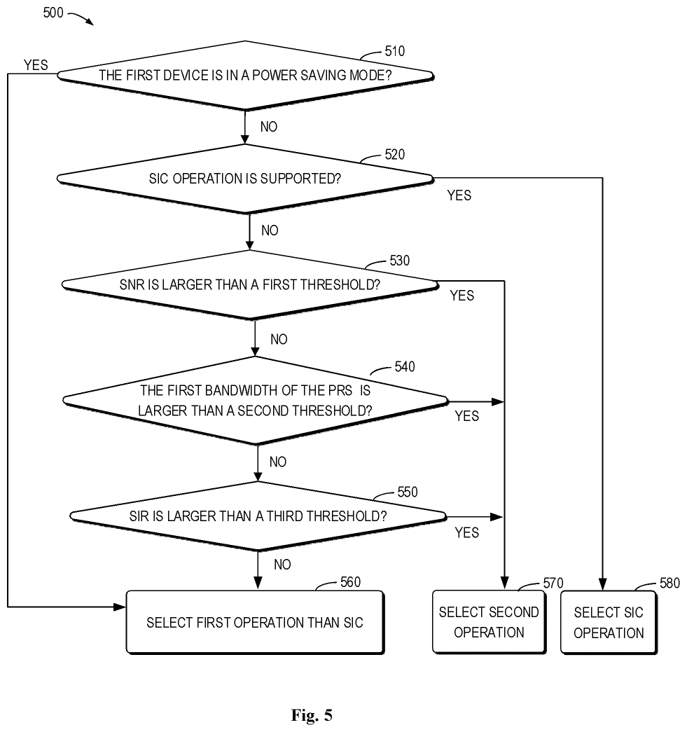

Reference is now made to FIG. 5, which shows a flowchart of an example method 500 implemented at a first device in accordance with some example embodiments of the present disclosure. The method 500 may be considered as an example implementation of the method 400. For the purpose of discussion, the method 500 will be described from the perspective of the first device 110 with reference to FIG. 1. However, the method 500 may be likewise applied to other communication scenarios.

At block 510, the first device 110 determines whether it is in a power saving mode. If the first device 110 is in the power saving mode, the method 500 proceeds to block 560. At block 560, the first device 110 selects the first positioning measurement operation other than the SIC operation. Hereinafter, for brevity, the first positioning measurement operation other than the SIC operation is also referred to as “operation #1”. On the other hand, if the first device 110 is not in the power saving mode, the method 500 proceeds to block 520.

At block 520, the first device 110 determines, based on capability of the first device 110, whether the SIC operation is supported by the first device 110. If the SIC operation is not supported, the method 500 proceeds to block 530.

At block 530, the first device 110 determines whether the first ratio of the received power of the PRS to noise power (also referred to as “SNR”) is larger than a first threshold. If the SNR is not larger than the first threshold, the method 500 proceeds to block 540.

At block 540, the first device 110 determines whether the first bandwidth of the PRS is larger than a second threshold. If the first bandwidth of the PRS is not larger than the second threshold, the method 500 proceeds to block 550.

At block 550, the first device 110 determines whether the second ratio of the received power of the PRS to the received power of the signal is larger than a third threshold. Hereinafter, for brevity, the second ratio is also referred to as “SIR”. If the SIR is not larger than the third threshold, the method 500 proceeds to block 560.

On the other hand, if the first device 110 determines, at block 520, the SIC operation is supported, the method 500 proceeds to block 580. At block 580, the first device 110 selects the SIC operation.

On the other hand, if the first device 110 determines, at block 530, the SNR is larger than the first threshold, the method 500 proceeds to block 570. At block 570, the first device 110 selects the second positioning measurement operation. Hereinafter, for brevity, the second positioning measurement operation is also referred to as “operation #2”.

If the first device 110 determines, at block 540, the first bandwidth of the PRS is larger than the second threshold, the method 500 proceeds to block 570.

If the first device 110 determines, at block 550, the SIR is larger than the third threshold, the method 500 proceeds to block 570.

It will be understood that the method 500 is just an example to show how the first device 110 determines when to use which positioning measurement operation. In this example, each of the criteria listed in FIG. 5 is tested sequentially, and an “AND” type of decision flow is implemented. However, it should be noted that other combinations and testing order may also be implemented. For example, the first device 110 may first implement an SIR test, after which the decision of whether to apply SIC is evaluated.

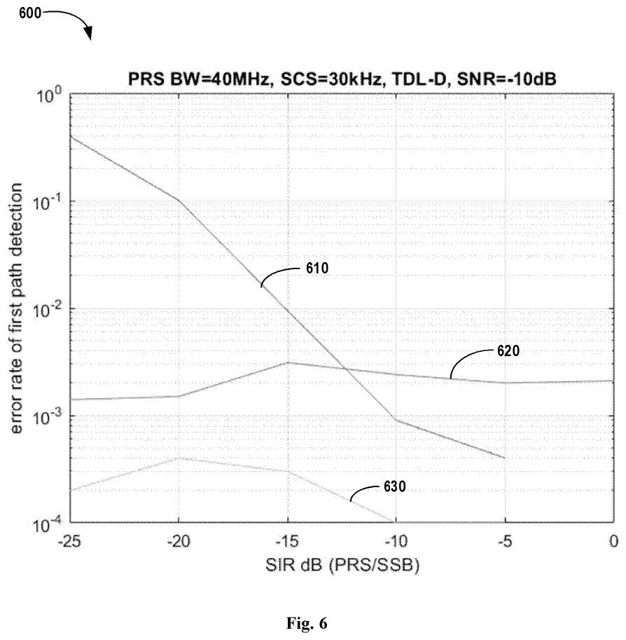

FIG. 6 illustrates a simulation result 600 of a method according to other example embodiments of the present disclosure. In the simulation, different positioning measurement operations are performed under different scenarios.

The assumed simulation parameters are as below: 40 MHz PRS bandwidth; 30 kHz subcarrier spacing (SCS); TDL-D LOS channel; −10 dB SNR. The second ratio of the received power of the PRS to the received power of the SSB varies from −25 dB to 0 dB.

Curves 610, 620 and 630 are associated with the operation #1, the operation #2 and the SIC operation, respectively.

From the simulation result 600, it can be observed that the SIC operation outperforms the operation #1 and the operation #2 in the whole SIR region. Here, we simply assume the most optimal case, i.e., the first device 110 can perfectly decode the SSB and cancel it from the received signal. In practical implementation, channel estimation error will degrade the performance of SIC operation. Hence, without perfect channel estimation, the real performance from the SIC operation will be somewhere between the curve 630 and the curve 610 in FIG. 6. In addition, due to high implementation complexity, the SIC operation may be only applicable for certain device. Furthermore, the operation #2 can achieve better positioning measurement in lower SIR region (from −25 dB to around −12 dB) compared to the operation #1. It shows the potential benefit of the adaptive positioning measurement according to some example embodiments of the present disclosure.

In some example embodiments, an apparatus capable of performing the method 400 (for example, the first device 110) may comprise means for performing the respective operations of the method 400. The means may be implemented in any suitable form. For example, the means may be implemented in a circuitry or software module. The first apparatus may be implemented as or included in the first device 110. In some example embodiments, the means may comprise a processor and a memory.

In some example embodiments, the apparatus comprises: means for receiving, at a first device from a second device, a signal on a first resource and PRS from at least one third device on a second resource, the first resource overlapping the second resource in time domain and partially overlapping the second resource in frequency domain; means for determining at least one of the following: quality of the received signal, quality of the received PRS, or configuration information about positioning measurement for the first device; and means for selecting, based on the determination, one of positioning measurement operations for the first device; and means for performing the selected positioning measurement operation.

In some example embodiments, the positioning measurement operations comprise at least one of the following: a first positioning measurement operation over whole resource elements of the second resource, or a second positioning measurement operation over partial resource elements of the second resource, In some example embodiments, the partial resource elements do not overlap the first resource.

In some example embodiments, the first positioning measurement operation comprises a successive interference cancellation operation.

In some example embodiments, means for determining the quality measurements of the received PRS comprises: means for determining a first ratio of a received power of the PRS to noise power.

In some example embodiments, means for determining the quality of the received signal and the quality measurements of the received PRS comprises: means for determining a second ratio of a received power of the PRS to a received power of the signal.

In some example embodiments, means for determining the second ratio comprises means for determining the second ratio based on one of the following: a third ratio of a received power of a first reference signal previously measured from the second device and a received power of a second reference signal previously measured from the third device, a distance between the second device and the third device, or an angle between the second device and the third device.

In some example embodiments, each of the first reference signal and the second reference signal comprises one of the following: an SSB, or a channel state information reference signal.

In some example embodiments, the configuration information about the positioning measurement for the first device comprise at least one of the following: a first bandwidth of the PRS, a ratio of the first bandwidth to a second bandwidth of the signal, capability of the first device, an operation mode of the first device, or positioning QoS requirements.

In some example embodiments, the first device comprises a terminal device, the second device comprises a terminal device or a network device, and the at least one third device comprises a terminal device or a network device.

In some example embodiments, the signal comprises at least one of the following: an SSB, or data associated with URLLC traffic transmission.

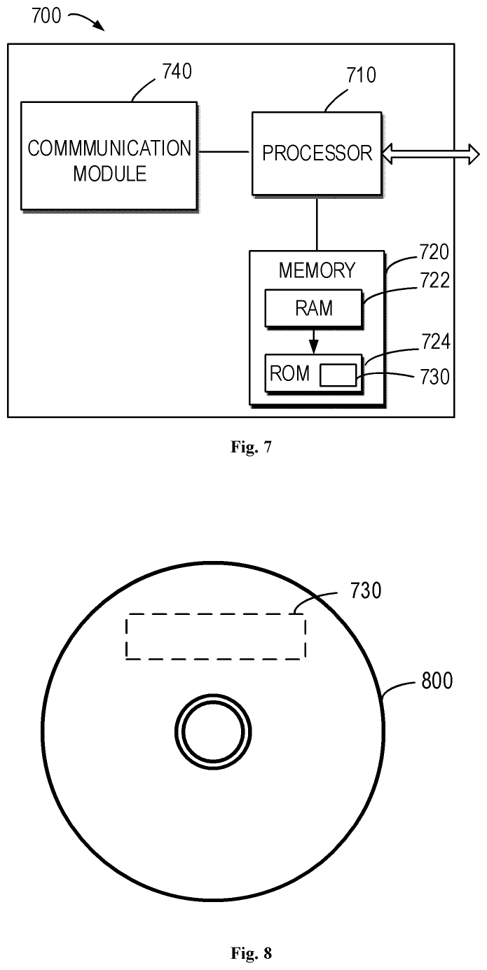

FIG. 7 is a simplified block diagram of a device 700 that is suitable for implementing example embodiments of the present disclosure. The device 700 may be provided to implement a communication device, for example, the first device 110 as shown in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not last in the power-down duration.

A computer program 730 includes computer executable instructions that could be executed by the associated processor 710. The program 730 may be stored in the memory, e.g., ROM 724. The processor 710 may perform any suitable actions and processing by loading the program 730 into the RAM 722.

The example embodiments of the present disclosure may be implemented by means of the program 730 so that the device 700 may perform any process of the disclosure as discussed with reference to FIGS. 4 to 5. The example embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 which may be in form of CD, DVD or other optical storage disk. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target physical or virtual processor, to carry out any of the methods as described above with reference to FIGS. 2 to 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

It should be appreciated that though some embodiments may be implemented by/at IAB nodes, solutions including methods and apparatus proposed in this disclosure could also be applied in other communication systems where similar technical problems exist. Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device, comprising:
at least one processor; and
at least one memory storing instructions that, when executed by the at least one processor, cause the first device at least to:
receive a signal from a second device on a first resource and positioning reference signal, PRS, from at least one third device on a second resource, the first resource overlapping the second resource in time domain and partially overlapping the second resource in frequency domain;
determine at least one of the following:
quality of the received signal,
quality of the received PRS, or
configuration information about positioning measurement for the first device; and
select, based on the determination, one of positioning measurement operations for the first device; and
perform the selected positioning measurement operation.

2. The first device of claim 1, wherein the positioning measurement operations
comprise at least one of the following:
a first positioning measurement operation over whole resource elements of the second resource, or
a second positioning measurement operation over partial resource elements of the second resource, wherein the partial resource elements do not overlap the first resource.

3. The first device of claim 2, wherein the first positioning measurement operation comprises a successive interference cancellation operation.

4. The first device of claim 1, wherein the first device is caused to determine the quality of the received PRS by:
determining a first ratio of a received power of the PRS to noise power.

5. The first device of claim 1, wherein the first device is caused to determine the quality of the received signal and the quality of the received PRS by:
determining a ratio of a received power of the PRS to a received power of the signal.

6. The first device of claim 5, wherein the first device is caused to determine the ratio based on one of the following:
a ratio of a received power of a first reference signal previously measured from the second device and a received power of a second reference signal previously measured from the third device,
a distance between the second device and the third device, or
an angle between the second device and the third device.

7. The first device of claim 6, wherein each of the first reference signal and the second reference signal comprises one of the following:
a synchronization signal and physical broadcast channel block, SSB, or
a channel state information reference signal.

8. The first device of claim 1, wherein the configuration information about the positioning measurement for the first device comprises at least one of the following:
a first bandwidth of the PRS,
a ratio of the first bandwidth to a second bandwidth of the signal,
capability of the first device,
an operation mode of the first device, or
positioning Quality of Service, QoS, requirements.

9. The first device of claim 1, wherein the first device comprises a terminal device, the second device comprises a terminal device or a network device, and the at least one third device comprises a terminal device or a network device.

10. The first device of claim 1, wherein the signal comprises at least one of the following:
a synchronization signal and physical broadcast channel block, SSB, or
data associated with ultra-reliable and low latency communications, URLLC, traffic transmission.

11. A method, comprising:
receiving, at a first device from a second device, signal on a first resource and positioning reference signal, PRS, from at least one third device on a second resource, the first resource overlapping the second resource in time domain and partially overlapping the second resource in frequency domain;
determining at least one of the following:
quality of the received signal,
quality of the received PRS, or
configuration information about positioning measurement for the first device; and
selecting, based on the determination, one of positioning measurement operations for the first device; and
performing the selected positioning measurement operation.

12. The method of claim 11, wherein the positioning measurement operations comprise at least one of the following:
a first positioning measurement operation over whole resource elements of the second resource, or
a second positioning measurement operation over partial resource elements of the second resource, wherein the partial resource elements do not overlap the first resource.

13. The method of claim 12, wherein the first positioning measurement operation comprises a successive interference cancellation operation.

14. The method of claim 11, wherein determining the quality measurements of the received PRS comprises:
determining a ratio of a received power of the PRS to noise power.

15. The method of claim 11, wherein determining the quality of the received signal and the quality measurements of the received PRS comprises:
determining a ratio of a received power of the PRS to a received power of the signal.

16. The method of claim 15, wherein determining the ratio based on one of the following:
a ratio of a received power of a first reference signal previously measured from the second device and a received power of a second reference signal previously measured from the third device,
a distance between the second device and the third device, or
an angle between the second device and the third device.

17. The method of claim 16, wherein each of the first reference signal and the second reference signal comprises one of the following:
an SSB, or
a channel state information reference signal.

18. The method of claim 11, wherein the configuration information about the positioning measurement for the first device comprises at least one of the following:
a first bandwidth of the PRS,
a ratio of the first bandwidth to a second bandwidth of the signal,
capability of the first device,
an operation mode of the first device, or
positioning Quality of Service, QoS, requirements.

19. The method of claim 11, wherein the first device comprises a terminal device, the second device comprises a terminal device or a network device, and the at least one third device comprises a terminal device or a network device.

20. The method of claim 11, wherein the signal comprises at least one of the following:
a synchronization signal and physical broadcast channel block, SSB, or
data associated with ultra-reliable and low latency communications, URLLC, traffic transmission.

21.-22. (canceled)
